(19) United States
(12) Patent Application Publication
(10) Pub. No.: US 2008/0290233 A1
(43) Pub. Date: Nov. 27, 2008

(54) CLAMPING SYSTEM

(76) Inventor: Andrew Brett McCoubrie, Bright (AU)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/123,409

(22) Filed: May 19, 2008

(30) Foreign Application Priority Data
May 18, 2007 (AU) 2007902675

(51) Int. Cl. F16B 7/04

(52) U.S. Cl. 248/228.7

(57) ABSTRACT

A clamp for clamping boards to a suitable support in which one part of the clamp engages a recess in one board and another part of the clamp engages part of the surface of the support to retain the board in a fixed relationship with the support. The clamp includes a fastening element which has a spacer portion for use in spacing two adjacent boards apart from each other when the boards are being clamped to the support to provide a uniform spacing of the boards. The advantage of the clamp is that it can be used to assemble a relocatable structure, such as an outdoor decking with evenly spaced boards and then the clamp can be released to allow disassembly of the structure which can then be reassembled at a different location using the same clamps.

### CROSS-REFERENCE TO RELATED APPLICATION

This application claims priority to Australian Patent Application No. 2007902675, filed May 18, 2007, which is incorporated herein by reference in its entirety.

### FIELD OF THE INVENTION

The present invention relates to a clamping system or fixing system for clamping or joining a multitude of individual members to each other in a predetermined arrangement to form a relocatable or demountable building structure.

### BACKGROUND OF THE INVENTION

Although the present invention will be described and illustrated with reference to a relocatable outdoor decking for forming an outdoor recreational area, entertaining area or living space, it is to be noted that the decking is one example of the structure than can be built using the clamping system or fixing system of the present invention and the description of the invention is applicable to other buildings and other structures. The description of the particular clamps and decking is meant to be illustrative of the invention rather than limiting of the scope of the invention. Examples of other structures include temporary walkways, particularly requiring drainage, temporary exhibition stands and the like.

Often, it is desirable to have an outdoor entertaining area or outdoor living area complementing the normal indoor area of a house to improve the lifestyle of the occupants of the house or dwelling. An example of one desirable outdoor area is an outdoor decking usually formed at the rear of a domestic dwelling or similar. Such deckings can be used for a variety of purposes and can be built in a variety of designs, forms and arrangements. Usually, such deckings are a fixed structure that are built onto the existing dwelling and require anchoring in place by the use of a suitable foundation or fixed framework including a support framework of stumps, posts, bearers and other supports and the like. Such structures are not movable and certainly are not relocatable or transportable and cannot be removed for reuse. Once constructed existing outdoor deckings are permanent and must remain with the dwellings as a permanent fixture.

The fixed and more or less permanent nature of decking and similar structures causes problems for occupants of a dwelling who are there temporarily, such as for example, people renting the property or who are occupying the property for a fixed duration, such as for example, when fulfilling a fixed term contract of employment or being relocated by an employer or for other reasons. In such situations, many occupants would like to have the advantage of an outdoor area such as a decking or similar structure but are prevented from doing so by the house not having an existing decking and/or the owner or landlord of the building being reluctant to go to the expense or effort of building a decking. Thus the temporary occupants have to go without having a decking which diminishes their enjoyment and/or lifestyle. Therefore, there is a need for a relocatable structure that can be built for temporary use for a fixed period of time by the temporary occupants of a building for the time being and which at the termination of the occupancy the structure can be disassembled or dismantled and removed to a new location which it can once again be erected or assembled.

Therefore, it is an aim of the present invention to provide a relocatable structure that can be assembled for use and after use can be readily disassembled.

One of the reasons that hitherto before it has not been possible to construct a relocatable or temporary structure, such as an outdoor decking or the like having sufficient strength and durability, was the requirement of providing a suitable fixing system or clamping system for joining the individual components of the decking or structure together with sufficient holding power to result in a safe and usable structure, yet allow ready dismantling of the structure without causing wastage of materials or damage to the material making them unsuitable for reuse or reassembly, such as for example, a satisfactory clamping system or fixing system having clamps that were strong enough to hold the decking together yet readily releasable to allow ready dismantling of the structure whilst at the same time being of a design that allowed them to be used flexibly and universally in a wide range of different situations and configurations when the building or structure was to be relocated.

Accordingly, in one embodiment the present invention resides in the development of a new fixing system or clamping system for joining the decking boards to the joists or bearers of an outdoor decking structure, particularly when the joists and bearers are in the form of purlins.

Another problem addressed by the present invention is being able to provide suitable clamps that can be located in place between adjacent decking boards to clamp the boards to the underlying support members whilst still allowing ready access to the clamps or fasteners to both tighten the clamps to form the decking and to release the clamps when dismantling the decking.

Another problem encountered in developing the present invention includes being able to locate the decking boards in substantially parallel spaced apart relationship to each other to provide a uniform appearance whilst fastening the decking boards to the bearers or joists.

A further problem encountered in developing the clamp or fixing system of the present invention has been to provide access to the fasteners or clamps after the structure has been built so that the structure can be readily disassembled by releasing the fasteners or clamps.

These problems of providing a suitable clamping system or fixing arrangement have been addressed by the present invention.

It is to be noted that not all forms of the fasteners or clamps of the present invention overcome all of the problems indicated above. Some embodiments address one problem whilst other embodiments address a different problem. Some embodiments address two or more problems.

### SUMMARY OF THE INVENTION

According to one aspect of the present invention there is provided a clamp capable of clamping a first member and a second member together with respect to each other in a selected clamped configuration, said clamp comprising a movable fastening element capable of movement to move the clamp between a clamping configuration and a release position by moving the fastening element about or along one axis of the fastening element, a holder for engaging with the second member to assist in retaining the second member with respect to the first member in the selected clamped configuration, and a clip cooperatively connected to the movable fastening element for engaging with the first member to assist in retaining the first and second member with respect to each other in the clamped configuration, wherein the fastening element, holder and clip are arranged with respect to each other so that when the clip is moved to the clamping configuration from the release position by movement of the fastening element the clip cooperatively engages the first member and the holder cooperatively engages the second member so as to clamp the first and second members with respect to each other in the selected clamped configuration at least in part intermediate the holder and the clip.

According to another aspect of the present invention there is provided a method of clamping two members to each other in a selected clamped configuration using a clamp having a moveable fastening element, a holder and a clip arranged to cooperatively interact with each other to clamp the two members in the selected clamped configuration comprising the steps of locating the first and second members with respect to each other, engaging the second member with the holder, engaging the first member with the clip, moving the fastening element from a released position to a clamping position to move the clip from a release position to a clamping position thereby clamping the two members with respect to each other in the selected clamp position by the cooperative interaction of the holder, clip and fastening element.

According to another aspect of the present invention there is provided a clamping system for clamping a first member to a second member in a selected clamped configuration to form a disassembleable structure made from a multitude of first and second members requiring joining together to form the structure, the system including at least one clamp for clamping the first member to the second member in a selected clamped configuration to provide part of the structure, said clamp having a movable elongate fastening element capable of movement about or along a central longitudinal axis of the fastener, a holder for cooperatively engaging with at least a part of the second member to assist in clamping the first and second members together in the selected clamped configuration, and a clip for cooperatively engaging with at least a part of the first member to assist in clamping the first and second members in the selected clamped configuration, wherein the holder and the clip are arranged with respect to the elongate fastening element so that movement of the elongate fastening element about or along the longitudinal axis from a release position to a clamping position causes corresponding movement of the clip about or along the longitudinal axis towards the holder so that the holder and clip cooperate with each other to clamp the first and second members to each other in the selected clamped configuration at least in part intermediate the holder and the clip.

According to another aspect of the present invention there is provided a clamping system for joining a single first member to a multitude of second members in a clamped configuration to form part of a structure capable of being disassembled when no longer required for use, the clamping system comprising a multitude of individual clamps for joining the multitude of second members to the single first member in the clamped configuration in which at least some of the second members are in regular spaced apart relationship to one another, wherein each of the clamps comprises a movable elongate fastening element for location between two of the second members and extending to the first member, said fastening element movable about or along an axis thereof, a holder for location between the two second members for engaging with the two second members to retain the two second members in spaced apart relationship to each other and to the first member in the clamped configuration to form part of the structure and a clip cooperatively connected to the fastening element for engaging with the first member to assist in retaining the first member and the two second members in the clamped configuration, said clamp being arranged such that movement of the fastening element about or along the axis thereof causes corresponding movement of the clip about or along the axis so as to move the clip and holder to a clamping position to clamp the first member and the two second members in the selected clamped configuration at least in part intermediate the holder and the clip.

In one form the clamping system is a fixing system for affixing individual components of a relocatable building structure to one another in a prearranged or planned manner to form the structure so that when the structure is no longer required for use the fixing system or clamping system can be easily released thereby allowing the individual components to be separated from each other so that the structure can be disassembled prior to being moved and/or reassembled elsewhere if required.

In one form, the present invention relates to a clamping system or fixing system for affixing a multitude of a first set of similar components to a multitude of a second set of similar components in which the two sets of components are different components to each other using a multitude of clamps or fasteners to affix individual ones of the one set of components in spaced apart relationship to individual ones of the other components which are also arranged in spaced apart relationship to each other to form a structure that is strong and robust which can be used as part of a building or support such as for example, an outdoor structure, living area, or the like and which can be readily disassembled when no longer required for use.

The present invention finds particular application as a clamping system or fixing arrangement for forming a decking or similar self supporting or self-bracing structure, which decking can be quickly assembled for use in one location and when required at another location can be readily disassembled by releasing the clamping or fixing system to allow the decking boards or planks to be removed from the underlying support and the underlying support can be disassembled so that the decking can be relocated and reassembled as a decking in the new location. The structure may be provided as a kit which requires assembly or as a do-it-yourself project for assembly by the home handy man.

It is to be noted that although the present invention will be described with particular reference to one form of the clamp or fixing system and to the use of the clamps to build one structure the scope of the present invention is not restricted to the described embodiment or embodiments but rather the present invention is more extensive in scope so as to include other forms and arrangements of the clamps, of the clamping or fixing system, of the individual components forming the system, and to different structures and to the use of the various components, systems or assemblies in a variety of other applications other than forming an outdoor decking.

### BRIEF DESCRIPTION OF THE DRAWINGS

The present invention will now be described by way of example with reference to the accompanying drawings.

FIG. 1 is an exploded perspective view of one form of the foundation of the underlying support structure for supporting a decking made in accordance with the present invention.

FIG. 2 is an exploded perspective view of one alternative form of the foundation.

FIG. 3 is an exploded perspective view on another alternative form of the foundation.

FIG. 4 is a partial top perspective view of one form of the decking built using the clamps of the present invention.

FIG. 5 is a partial top perspective view of one form of the clamp of the present invention in situ clamping one decking board to one purlin in accordance with the present invention.

FIG. 6 is an enlarged top perspective view of the clamp of FIG. 5.

FIGS. 7a, 7b, 7c and 7d are perspective views of different alternatives of the clamp of the present invention showing different forms of the fastening element and of the clip.

FIGS. 8a, 8b, 8c, 8d, 8e, 8f and 8g are perspective views of different alternatives of the clip of the present invention.

FIGS. 9a, 9b, 9c, 9d, 9e and 9f are perspective views of still further different alternatives of the clip of the present invention.

FIG. 10 is a perspective view of an alternative form of the holder of the present invention in the form of a joiner.

FIG. 11 is an enlarged view of the joiner of FIG. 10.

FIG. 12 is a partial perspective view of a modified form of the purlin in the form of a slotted purlin.

FIG. 13 is an enlarged view of the slotted purlin of FIG. 12.

FIG. 14a, 14b, 14c are cross-sectional views of alternative form of the holder.

### DETAILED DESCRIPTION OF THE INVENTION

Aspects of the present invention will now be described.

Typically, the relocatable structure of the present invention is an outdoor decking, an outdoor entertainment area, a boardwalk, a tank stand, a temporary flooring system or structure, a walkway, steps, an exhibition stand, a covering system or structure having drainage characteristics such as for use in a marine environment, aquatic environment or the like, a wharf, a pier, a structure for use in snow and/or icy conditions, or other suitable structure. Preferably, the structure is an outdoor decking comprising a covering of individual members and an underlying structure.

Preferably, the underlying support structure includes foundations, footings, pillars, posts, uprights, bearers, joists or the like. More preferably, the individual support members or elements are metallic, including being made from corrosion resistant material, such as for example, galvanized metal, treated metal or the like or are made from timber such as treated timber including treated pine or similar.

Preferably, the underlying support structure is also disassembleable, or demountable or dismantleable or the like. In one form, the decking system does not normally require the use of permanent concrete footings. It is intended that an adjustable metal baseplate attaches to a durable timber or recycled plastic soleplate to spread the load of the deck over a greater surface area to the ground below. This soleplate could be a cobblestone, a prefabricated removable concrete paver or other suitable foundation.

In one form, the building structure is modular, comprising a number of different sets of components, such as bundles of planks or the like. In other forms, the building structure is a kit containing separate components. In another form the building structure is at least partially prefabricated into component parts which require assembly together to form the building structure.

In one form the first member is a bearer, joist, support member or similar. Preferably, the first member is a purlin. Even more preferably, the purlin is a C-shaped purlin. More preferably, the C-shaped purlin is a metallic purlin. Even more preferably, the C-shaped purlin has a flange at the edge of the opening or is located on the open side. More preferably, there are two flanges forming lips, one located along one edge of the open side, the other located along the other edge of the open side. Most preferably, the clip or part of the clip engages one of the lips or flanges in use, preferably the upper lip or flange in use. In one embodiment the upper surface of the metallic purlin is slotted. Alternatively, the first member is a timber rail, bearer, joist or similar. In some embodiments, the first member is a pair of members arranged in back to back relationship on either side of a post or similar upright support or the like.

Typically the second member of the present invention is an elongate member in the form of a board, plank, strip, panel, cover or the like. Typically there is a multitude or plurality of second members in the form of a decking board of the type suitable for use in constructing an outdoor decking or similar structure. More preferably, the decking boards are a composite material, a composite plastic decking board, such as recycled plastic, a plastic and fiberglass composite, a plastic and sawdust composite, timber, such as for example, made from hardwoods or softwoods, treated timbers, and the like including treated pine, merbau, meranti, balau, jarrah, cedar, pine, karri, red gum, ironbark, tallow wood, yellow stringy bark, spotted gum or the like.

Preferably the decking board is provided with a part, section, portion, fitting or similar for engaging with the holder. In one form the board is provided with a groove, rebate, aperture, bore, slot, rabbet, or the like. More preferably, there is a groove extending along one side edge of the board. More preferably, there is a groove on either longitudinal side edge of the board. In some forms the groove is continuous extending along the entire length of the board whereas in other forms the groove is discontinuous having spaced apart sections provided with grooves whilst other intermediate parts are not provided with grooves. The grooves, etc., are for receiving the holder or part of the holder. The size of the groove, such as the thickness of the groove is matched to the dimensions of the holder. In one form, the profile of the groove is square or rectangular having two substantially parallel sides and a perpendicular end wall. In other embodiments, the profile can be curved, such as for example, having a curved or rounded end wall between the two substantially parallel sides.

In one form, joiners can be located in the groove, such as for example, biscuit joiners or the like for joining two planks in side-by-side or in end-to-end relationship. In another form, there are separate grooves located in spaced apart relationship in the form of a multitude of slots or recesses located along the edges of the boards to receive biscuits, wafers or similar to join the boards. In some forms, the joiner, biscuit or wafer located in the slots or grooves acts as a spacer to maintain a preset spacing between adjacent boards.

In one form the fastening element is a threaded elongate fastening element having a thread extending almost entirely along the longitudinal axis of the fastener. Preferably, the fastener is provided with an enlarged head or shoulder. More preferably, the head or shoulder portion forms a spacer for fitting between the side edges of adjacent boards to space the boards in regular spaced apart relationship, preferably in regular spaced apart parallel relationship, to each other to form a uniform spacing of the boards of the decking. Preferably, the fastener is a screw, bolt, or other threaded fastener having a head, and a threaded shank or shaft. Preferably, the head acts as a spacer for spacing the decking boards apart form each other, preferably adjacent decking boards.

In one form, the holder of the present invention is a plate, joiner, disc, washer, tie, strap, biscuit, wafer or other fitting. Preferably the holder is planar, flat, smooth surfaced or the like and engages the groove of the decking board to retain the board in place by being received in the groove. Alternatively, the holder can be curved, domed, spring-like or other out-of-plane shape introducing a degree of springyness to the holder to accommodate movement or deflection of the boards during use whilst still retaining the boards in end-to-end or side-by-side relationship.

Preferably, the holder is provided with an aperture, hole, bore, or the like. Preferably the hole, etc., is centrally located. In one form the holder is a washer. More typically, the washer is of a thickness corresponding to the dimensions of the groove so that the edge or peripheral portion of the washer can be snugly received within the groove to retain the decking board in place or is an interference fit in the groove of the decking board. Preferably, opposite edges of the washer are received in respective grooves of two adjacent boards when the grooves are in opposite face to face relationship to each other when the boards are in side by side spaced apart relationship. Preferably, the plane of the washer or holder is in the same plane as the plane of the groove so that the board and washer are coplanar, such as by being both arranged horizontally to inhibit the plank from twisting, warping, bending, buckling or the like. In other forms, the holder is stepped having two sections of different thicknesses.

In one form the washer is circular whereas, in other forms the washer can be elliptical, square, rectangular, oval, or any suitable polygonal shape or the like. Typically, the washer is provided with rectilinear edges, flats or corners or be bevelled to allow ease of access into or withdrawal from the grooves. Typically, the profile of the washer matches closely the profile of the groove. Typically, the washer is provided with curved or arcuate ends or side sections. In some embodiments the washer is provided with a boss, flange, collar, support or similar.

In one form the holder joins to planks or boards in spaced side-by-side relationship whereas in other forms the holder is in the form of a joiner, particularly an oval shaped joiner such as a biscuit for joining two planks in end-to-end collinear relationship to each other.

In one form the clip cooperatively engages with the purlin. The clip can take a variety of different forms. Typically the clip has a portion for fitting under the lip or flange of a lipped C-shaped purlin to cooperatively engage the purlin.

Typically, the clip has a bent or folded configuration such as for example in the form of a hook, having a shank and a tip. Preferably, the shank is straight and the tip is curved. More typically, the clip is flat, stepped, curved, or the like. Even more typically, the clip is L-shaped, J-shaped, V-shaped, U-shaped, or other suitable shape. Typically, the hook part is of a complex shape, such as a folded or bent shape having two or more parts angularly inclined to one another. Alternatively, the clip is provided with a collar, boss or similar. In one form, the clip is provided with fingers, tines or other projections for engaging against a surface of the purlin.

In the drawings there is shown one form of the clamping or fixing system of the present invention used in the construction of a relocatable decking, generally denoted as 2, as one example of the structure that can be built or assembled using the present invention. Other variations of the structure and of the fixing system are possible.

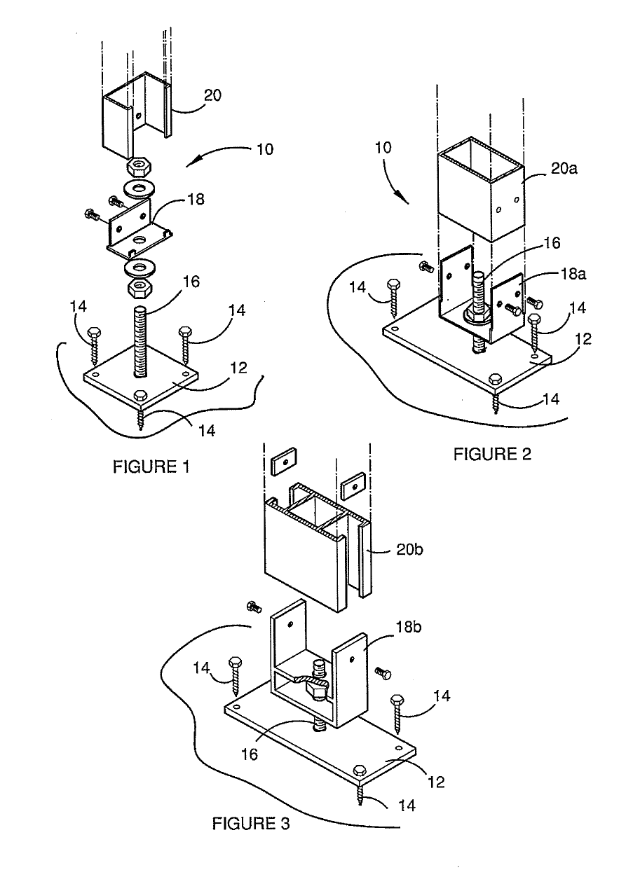

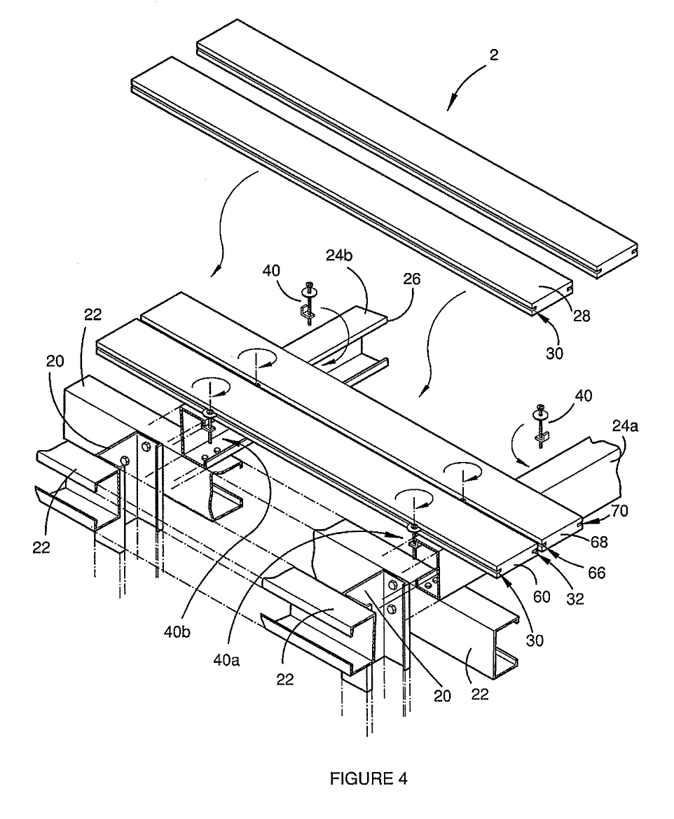

The foundation of the relocatable outdoors decking can be a conventional foundation or can be a specialized foundation. One form of the specialized foundation 10 is shown in FIG. 1. The foot of the foundation includes a base plate 12 which is set upon a suitable footing (not shown) such as a timber/recycled plastic soleplate, concrete pad, or paving stone that spreads the load to the underlying ground by a suitable number of fasteners, such as four fasteners as shown in the drawings, in the form of screws, threaded bolts 14, masonry anchors or the like. A threaded support pin 16 extends upwardly from plate 12 for receiving thereon a generally L-shaped bracket 18 which is secured to pin 16 by suitable fasteners such as nuts and washers as shown in FIG. 1. A metallic post having a generally C-shaped profile 20, is fitted to bracket 18 and fastened thereto to form one of the supports for the decking. It is to be noted that the vertical side of bracket 18 is received within the interior of the C-shaped profile of post 20 to securely retain the post. Alternative forms of the foundation and/or footings are possible, such as the alternative arrangements shown in FIGS. 2 and 3 which show alternative forms of the bracket 18a, 18b and alternative profiles of the post 20a, 20b. Whatever form of the post, the decking 2 is supported upon the posts as shown more particularly in FIG. 4.

One of the bearers 22 or a pair of similar bearers 22 located in back to back relationship on either side of post 20, as shown in FIG. 4, of the decking 2 are fixedly connected collectively to the top of posts 20 by suitable demountable or releasable fasteners, such as for example, threaded screws or bolts and extend between the posts 20 in one direction to form part of the underlying support for the decking. Having a pair of bearers 22 provides inherent bracing thus making the structures stronger. Joists in the form of generally C-shaped profile of metallic purlins 24, are fixedly connected collectively to bearers 22 to extend transversely between the bearers to also provide support for decking 2. Again demountable fasteners, such as threaded screws or bolts are used to connect joists 24 to bearers 22. Purlin 24 is provided with a lip in the form of a small flange 26 extending along the length of the purlin at both edges of the open side of the purlin. The two flanges are arranged to face one another on opposite sides of the opening. The arrangement of foundations, posts, bearers and joists forms the support for the decking. It is to be noted that the C-shaped profile of purlins 24 are one form of the first members of the present invention and that the clamp of the present invention engages with the upper of the two flanges at the lip of the opening of the purlin.

One form of connecting the deck boards 28 to the purlins 24 by the clamps 40 of the present invention will now be described. Deck boards 28 are arranged to extend transversely to the direction of purlins 24 but parallel to the direction of bearers 22. Other arrangements of the deck boards are possible such as for example, the directions of the two sets being angularly inclined to one another.

In one form clamp 40 comprises an elongate fastening element in the form of a relatively small diameter bolt or screw 42 having a threaded shaft 44 and an enlarged generally cylindrical head portion 46 provided with one or more slots 48 such as a screw head, a Phillips screw head, a Pozidriv® screw head, a square drive head, a hex slot screw head of the like for being engaged by a driver having a corresponding or complementary tip for being received in the slotted head, such as a screw driver or similar tool.

A holder in the form of a disc having a centrally located aperture, such as a washer 50 or similar is provided on shaft 44 of screw 42 near to enlarged head 46. The peripheral portion of washer 50 engages with one or more of the grooves 30 provided in deck boards 28 as will be described in more detail later in the specification. It is to be noted that the holder can take any suitable form or configuration and be of any suitable size, shape or type.

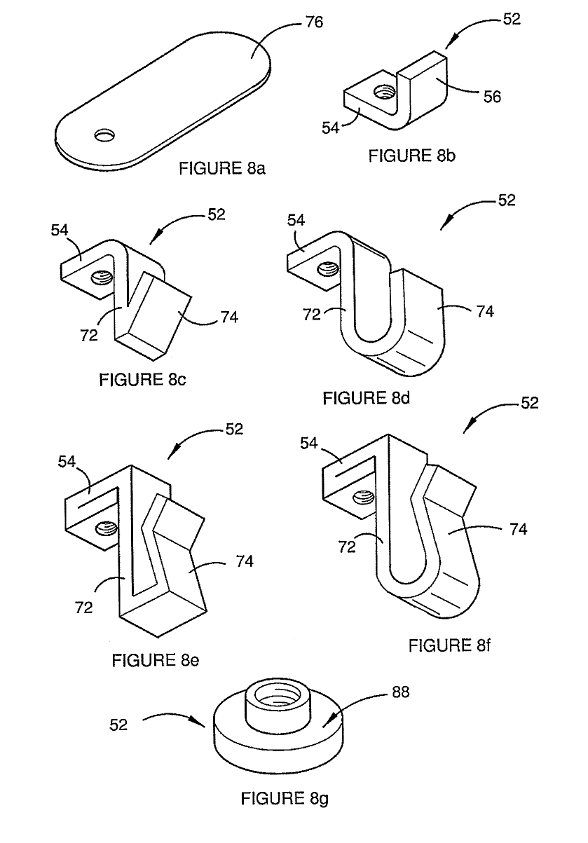

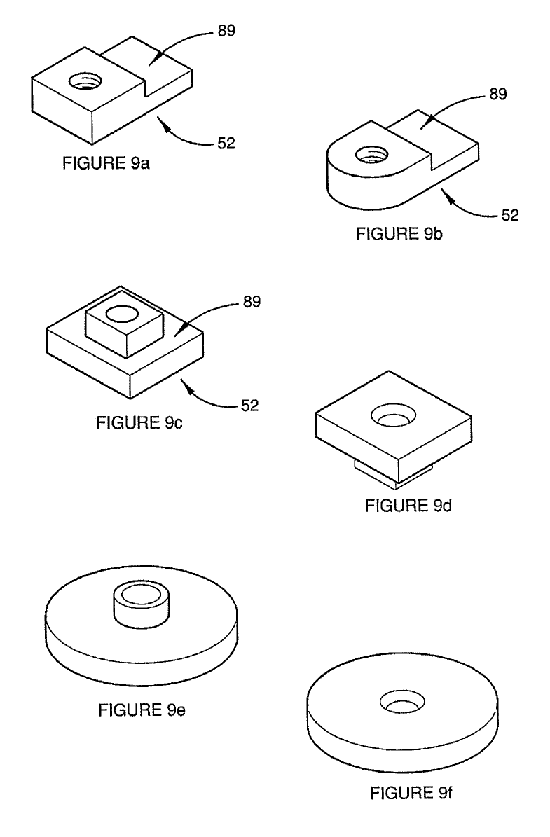

One form of the clip is a generally L-shaped clip 52 having an internally threaded bore or aperture centrally located in one arm 54 of the L-shaped clip. Clip 52 is threadingly received on shaft 44 of fastener 42 so that as fastener 42 is rotated clip 52 moves axially along the shaft depending upon the direction of rotation of fastener 42. The other arm 56 of L-shaped clip 52 is arranged to cooperatively engage the underside of one of flanges 26 of purlin 24, being the upper lip in use. As bolt 42 is rotated in a clockwise direction clip 52 moves axially closer towards washer 26 to clamp decking board to purlin 24. It is to be noted that clip 52 can take any suitable form or configuration or be of any size, shape or type so long as it can engage purlin 24 or flange 26 to clamp the decking boards to the purlins. Alternative forms of the clip 52 are shown in FIGS. 8 and 9. It is to be noted different forms of the clip can be used in different applications. The alternative forms of clips 52 have an internally threaded bore located on one arm 54 and a hook on the other arm comprising a shank 72 and tip 74. The shank 72 is usually straight whereas the tip is usually curved, bent or otherwise angularly inclined.

Operation of the clamping system of the present invention will now be described.

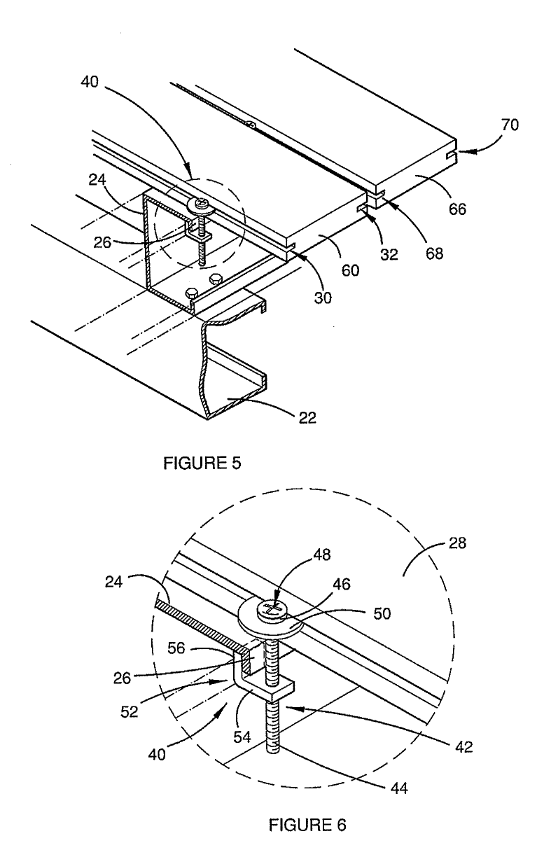

After providing suitable foundations or support, the bearers 22 and joists 24 are also bolted into position to form the supporting framework 10 for the decking 2 to be built. With particular reference to FIGS. 4 and 5 the first decking board 60 is located on the underlying purlins 24 to span between the purlins 24a, 24b. A first clamp 40a is located adjacent one side edge of board 60 having lengthwise extending groove 62. An edge of washer 50 is located within groove 62 so that washer 50 extends perpendicularly from the edge of board 28.

Arm 56 of clip 52 is located under flange 26 so as to engage flange 26. With washer 50 and clip 52 in place, screw 42 is rotated in a clockwise direction to draw washer 50 closer to clip 52 to squeeze board 60 to purlin 24a and thus clamp board 60 and purlin 24a together. A second identical clamp 40b is located between board 60 and a second purlin 24b to also clamp board 60 to purlin 24b. After the first board 60 has been clamped in place using the required number of clamps 40 a second board 66 is located next to first board 60. Second board 66 has two lengthwise extending grooves 68, 70, one on either side. Board 66 is spaced apart from board 60 by the width of head 46 of screw 42 so that the head acts as a spacer to provide correct spacing between adjacent boards 60, 66 to ensure an even gap over the entire length of the boards. With the second board 66 in position a multitude of clamps 40 can be used to clamp board 66 to the purlins by the washers 50 of each clamp 40 being received in the pair of grooves 32, 68 of adjacent boards in face to face opposing relationship to one another. Again washer 50 extends perpendicularly between two boards 60, 66.

When the decking is no longer required it can be dismantled and removed by merely using a screw driver or similar tool, either manually or motorised, to loosen each screw 42 thereby releasing washers 50 from between adjacent boards and releasing clips 52 from purlins 24 so that clamp 40 can be removed thus allowing the boards to be removed from the purlins thereby allowing the decking to be dismantled. As head 46 of screw 42 also acts as a spacer, to keep the boards apart from each other, the gaps between adjacent boards allows easy access to the screws located in the gaps between adjacent boards for tightening and loosening of the clips holding the boards in a clamped configuration to the purlins since the gaps are large enough to admit the tip of a screw driver or similar tool. Thus, the clips can be tightened for maintenance during use of the decking should it become necessary from time to time.

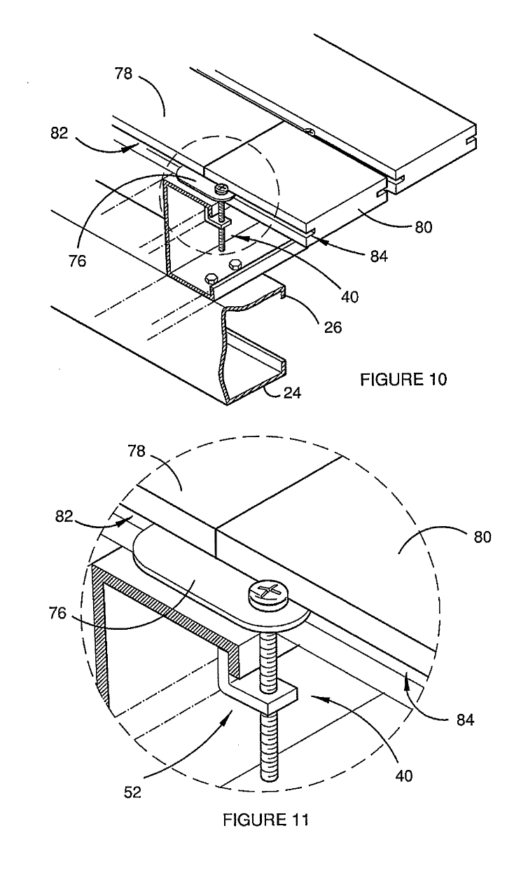

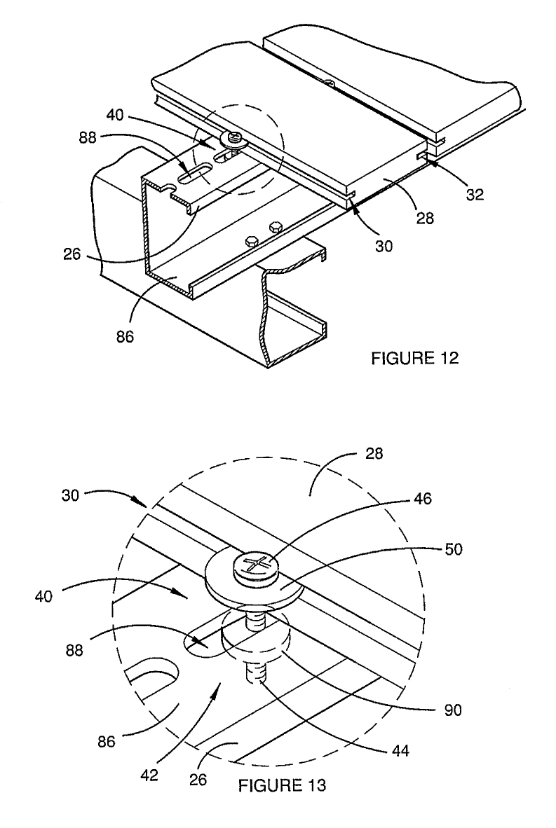

One modification of the clamp of the present invention includes the use of a joiner 76 to join two boards 78, 80 end-to-end as shown in FIGS. 10 and 11. In this embodiment joiner 76 is essentially an elongate plate or tie having two longitudinal sides and two curved ends arranged in a generally oval or elliptical shape. In use of joiner 76 the joiner can be considered as having two halves divided along the transverse central axis in which one side of one half engages with the groove 82 of one board 78 and the side of the other half engages with the groove 84 of the other board 80 as shown in FIGS. 10 and 11 so that as clamp 40 is tightened to the clamping position joiner 76 contacts both boards to join them end to end and to clamp both simultaneously to the underlying purlin 24. Thus, the joiner joins two boards together and clamps them in the one operation of tightening the clamp which reduces the time taken to assemble the decking.

Another modification of the clamping system of the present invention involves the use of slotted purlins for receiving alternative clips to engage the purlins. In this embodiment shown in FIGS. 12 and 13, purlin 86 is provided with a multitude of elongate slots 88 located along the upper surface in use of purlin 86. Elongate slots 88 can have any shape, size or be in any configuration and be arranged in any pattern. Clamp 40 used with the slotted purlins is modified by having an alternative form of the clip. In this embodiment the clip is in the form of an annular plug 90 having an internally threaded aperture for being threadingly received on the shaft 46 of the threaded bolt 42. Other forms of the clip as shown in FIGS. 8 and 9 can also be used with the slotted purlin. Some forms of clip 52 have a stepped wall arrangement 89 for engaging the undersurface of flange 26 of purlin 24 as shown more particularly in FIGS. 9a, 9b and 9c.

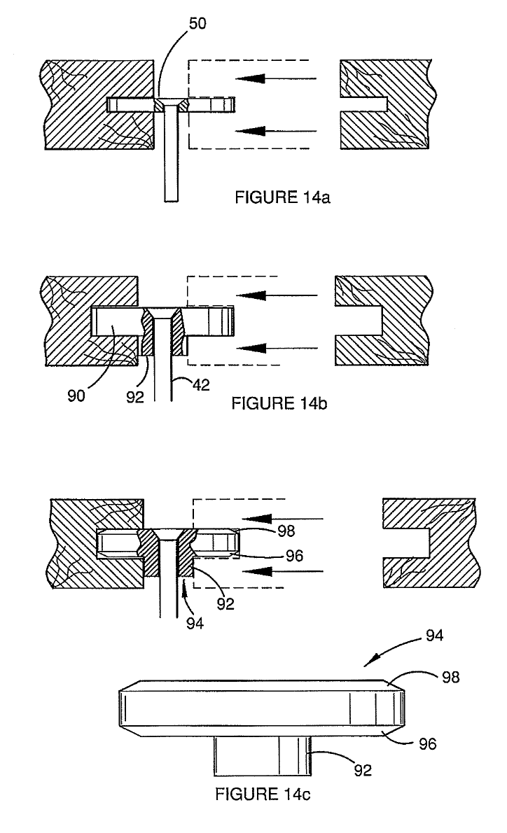

Variations of the holder are also possible. Examples of such variations are shown in FIGS. 14a, 14b and 14c which illustrate three different configurations taken by the holder, being variations on the basic washer such as a relatively slim washer 50 as shown in FIG. 14a, a relatively thick washer 90 having a boss or collar 92 located on one surface for receiving the head of screw 42 and providing a spacer to separate two adjacent boards as shown in FIG. 14b, and a washer 94 having a bevelled upper and lower edge 96, 98, together with an upstanding boss or collar 92 as shown in FIG. 14c. It is to be noted that the boss or collar present on the washer, is designed to space the boards apart from each other to a uniform spacing.

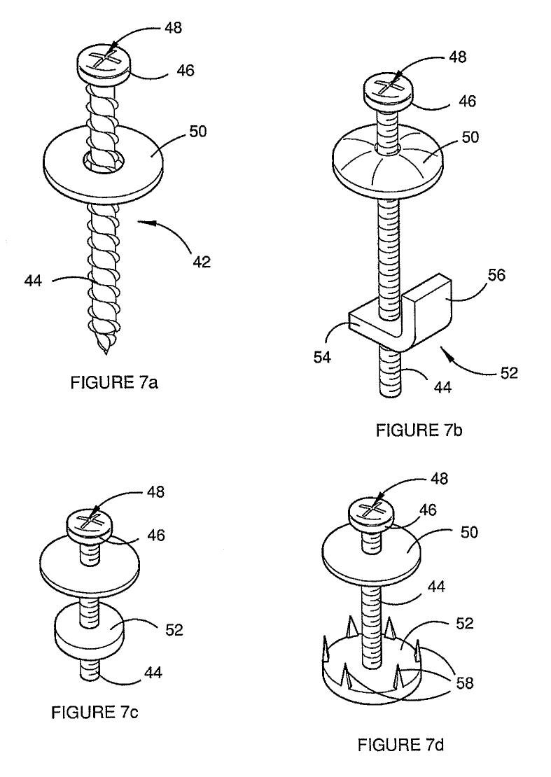

One variation of the clip, shown in FIG. 7d is provided with upstanding fingers or tines 58 for engaging the C-shaped purlin to secure the purlin to the planks 28.

Advantages of the present invention include that the construction or assembling of the relocatable structure requires minimum site excavation to provide a level foundation because of the adjustability of the upright posts.

Also, the decking boards can be inverted to prolong the life of the boards by exposing another surface of the boards i.e. exposing the undersurface.

Additionally, the boards can have two surface treatments, a different treatment on either side, to produce different appearances, finishes, textures or the like to achieve two different ‘looks’ or aesthetic finishes or the like.

The relocatable structure made in accordance with the present invention can be used over easements, drainways, or the like where currently it is not possible to build or construct a permanent structure.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

What is claimed is:

1. A clamp capable of clamping a first member and a second member together with respect to each other in a selected clamped configuration, said clamp comprising a movable fastening element capable of movement to move the clamp between a clamping configuration and a release position by moving the fastening element about or along one axis of the fastening element, a holder for engaging with the second member to assist in retaining the second member with respect to the first member in the selected clamped configuration, and a clip cooperatively connected to the movable fastening element for engaging with the first member to assist in retaining the first and second member with respect to each other in the clamped configuration, wherein the fastening element, holder and clip are arranged with respect to each other so that when the clip is moved to the clamping configuration from the release position by movement of the fastening element the clip cooperatively engages the first member and the holder cooperatively engages the second member so as to clamp the first and second members with respect to each other in the selected clamped configuration at least in part intermediate the holder and the clip.

2. The clamp according to claim 1 for incorporation into a kit or set of components for making the structure modular comprising a number of different sets of components or for incorporation into a prefabricated arrangement in which some components are part assembled.

3. The clamp according to claim 1 in which the first member is a bearer, joist, purlin, support member or similar.

4. The clamp according to claim 3 in which the purlin has a C-shaped profile having an opening defined between a pair of edges in which a flange is located at or towards the edges of the opening.

5. The clamp according to claim 4 in which the purlin has two flanges forming lips, one located along one edge of the open side of the C-shaped profile and the other located along the other edge of the open side of the C-shaped profile, the opening for receiving a part of the fastening element.

6. The clamp according to claim 5 in which the clip or part of the clip, engages one of the lips or flanges at or towards the opening of the C-shaped profile purlin, preferably the upper lip or flange in use.

7. The clamp according to claim 3 in which the purlin has an upper surface and a lower surface in which the upper surface of the metallic purlin is slotted or provided with a multiplicity of discontinuities, apertures, slots or the like for receiving part of the fastener therethrough to clamp the purlin to another member.

8. The clamp according to claim 1 in which the second member is provided with a part, section, portion, fitting or component, for engaging with the holder of the clamp to assist in retaining the first and second members in a clamped configuration.

9. The clamp according to claim 1 in which the second member is provided with a receiving portion for receiving part of the fastener to assist in clamping the first and second members in an clamped configuration.

10. The clamp according to claim 9 in which the receiving portion is a groove, rebate, aperture, bore, slot, rabbet, indentation for receiving therein the holder to assist in clamping the second member to the first member.

11. The clamp according to claim 10 in which joiners are locatable within the receiving portion of one or more second members wherein the joiners are in the form of biscuit joiners or similar for use in joining the second members in side-by-side or in end-to-end relationship with respect to one another.

12. The clamp according to claim 1 in which the fastening element is a threaded elongate fastening element having a thread extending substantially along a longitudinal axis of the fastener.

13. The clamp according to claim 1 in which the fastener further comprises an enlarged head or shoulder portion for forming a spacer for fitting between the side edges of adjacent second members to space the members in regular spaced apart relationship to one another to form a uniform spacing of the members.

14. The clamp according to claim 1 in which the holder is a plate, joiner, disc, washer, tie, strap, biscuit, wafer or other fitting which is planar, flat, smooth surface or the like for engaging with the receiving portion of the second member.

15. The clamp according to claim 1 in which the holder is curved, domed, spring-like or other out-of-plane shape introducing a degree of resilience or springyness to the holder to accommodate movement or deflection of the boards during use whilst still retaining the boards in end-to-end or side-by-side relationship.

16. The clamp according to claim 9 in which the holder is provided with an aperture, hole, bore, indentation or the like having a thickness corresponding to the thickness of the receiving portion of the board so that it can be snuggly received within the receiving portion or as an interference fit within the receiving portion to retain the decking board in place.

17. The clamp according to claim 16 in which the plane of the washer or holder is in the same plane as the plane of the receiving portion so that the board and washer are co-planar or substantially parallel such as by being both arranged horizontally to inhibit the plank from twisting, warping, bending, buckling or the like.

18. The clamp according to claim 17 in which the holder has a stepped portion having two sections of different thicknesses arranged side-by-side.

19. The clamp according to claim 1 in which the clip has a bent or folded configuration such as in the form of a hook having a shank portion and a tip portion in which the shank portion is straight and the tip portion is curved or inclined or extends out of the plane of the shank portion.

20. The clamp according to claim 19 in which the clip is L-shaped, J-shaped, V-shaped, U-shaped or any other suitable shape including a complex shape in which the hook part is of a complex shape including a folded or bent shape having two or more parts angularly inclined to one another.

21. A method of clamping two members to each other in a selected clamped configuration using a clamp having a moveable fastening element, a holder and a clip arranged to cooperatively interact with each other to clamp the two members in the selected clamped configuration comprising the steps of locating the first and second members with respect to each other, engaging the second member with the holder, engaging the first member with the clip, moving the fastening element from a released position to a clamping position to move the clip from a release position to a clamping position thereby clamping the two members with respect to each other in the selected clamp position by the cooperative interaction of the holder, clip and fastening element.

22. A clamping system for clamping a first member to a second member in a selected clamped configuration using a clamp in accordance with claim 1 to form a disassembleable structure made from a multitude of first and second members requiring joining together to form the structure, the system including at least one clamp for clamping the first member to the second member in a selected clamped configuration to provide part of the structure, said clamp having a movable elongate fastening element capable of movement about or along a central longitudinal axis of the fastener, a holder for cooperatively engaging with at least a part of the second member to assist in clamping the first and second members together in the selected clamped configuration, and a clip for cooperatively engaging with at least a part of the first member to assist in clamping the first and second members in the selected clamped configuration, wherein the holder and the clip are arranged with respect to the elongate fastening element so that movement of the elongate fastening element about or along the longitudinal axis from a release position to a clamping position causes corresponding movement of the clip about or along the longitudinal axis towards the holder so that the holder and clip cooperate with each other to clamp the first and second members to each other in the selected clamped configuration at least in part intermediate the holder and the clip.

23. A clamping system for joining a single first member to a multitude of second members in a clamped configuration using a clamp in accordance with claim 1 to form part of a structure capable of being disassembled when not required for use, the clamping system comprising a multitude of individual clamps for joining the multitude of second members to the single first member in the clamped configuration in which at least some of the second members are in regular spaced apart relationship to one another, wherein each of the clamps comprises a movable elongate fastening element for location between two of the second members and extending to the first member, said fastening element movable about or along an axis thereof, a holder for location between the two second members for engaging with the two second members to retain the two second members in spaced apart relationship to each other and to the first member in the clamped configuration to form part of the structure and a clip cooperatively connected to the fastening element for engaging with the first member to assist in retaining the first member and the two second members in the clamped configuration, said clamp being arranged such that movement of the fastening element about or along the axis thereof causes corresponding movement of the clip about or along the axis so as to move the clip and holder to a clamping position to clamp the first member and the two second members in the selected clamped configuration at least in part intermediate the holder and the clip.
